(19) United States
(12) Patent Application Publication
(10) Pub. No.: US 2003/0194886 A1
(43) Pub. Date: Oct. 16, 2003

(54) Electrohydraulic control system

(76) Inventors: Sebastian M. Mundry, Ludinghausen (DE); Jens Titschert, Lunen (DE); Franz-Heinrich Suilmann, Laer (DE)

Correspondence Address: Joel H. Bock, Cook, Alex, McFarron, Manzo,, Cummings & Mehler, Ltd., 200 West Adams Street-Suite 2850, Chicago, IL, 60606, US

(21) Appl. No.: 10/411,602

(22) Filed: Apr. 10, 2003

(30) Foreign Application Priority Data
Apr. 10, 2002 (DE) 10215576.3

(51) Int. Cl. H01R 12/00

(52) U.S. Cl. 439/76.1

(57) ABSTRACT

The present invention relates to an electrohydraulic control system (10) for an underground support system, with a valve block (1) which accepts grouped electrically-operated actuators for example electro-magnets (2, 2′) and several control valves of hydraulic valves switched with these electro-magnets and with a circuit board (7) containing an electronic circuit to which all the actuators (2, 2′) of the valve block (1) are connected through a disconnectable plug-in connection. The circuit board (7) is connected via a cable (21) to a controller (20) for data communication in the support system. The invention allows simultaneous connection of all the electro-magnets (2,2′) with the circuit board (7). For this purpose the circuit board (7) is located in a hood-type enclosure part (9) which is attachable to the back (3) of the valve block (1) and when assembled forms a sheet over all the electro-magnets (2,2′). The connector parts (6 to 6′″), which are essentially rigidly fixed to the circuit board (7), and cast in sealing compound (19), the arrangement of which connector parts (6 to 6′″) is matched to the grouping of the electro-magnets (2, 2′) on the valve block (1) , which connector parts (6 to 6′″) engage simultaneously in associated plug-in sockets (5) on the electro-magnets (2,2′) when the hood (9) is assembled.

The present invention relates to an electrohydraulic control system for an underground support system with a valve block which accepts grouped electrically-operated actuators for example electro-magnets and several control valves for hydraulic valves switched with the said actuators which electrohydraulic control system further comprises a circuit board containing an electronic circuit, to which all the actuators of the valve block are connectable through a disconnectable plug connector, by which disconnectable plug connector the circuit board is connectable to a controller for data communication, data recording and evaluation of operational status data from support units connected thereto.

Previously proposed electrohydraulic control systems of this construction have long been in use for underground workings. It is also previously proposed to integrate the actuators, which generally comprise electro-magnets, and the hydraulic valves of a mutually adjacent support unit on a valve block, which is fixed to the powered support assembly of a support unit. For safety reasons the controller for the electrohydraulic valves on said valve block, which is provided with manually operated combined electric locks and circuit controllers and an automatic safety device, is fixed in each case to the adjacent powered support assembly and connected to the electro-magnets either directly through a cable connector or with interposition of a valve actuation strip. In embodiments with a valve actuation strip, the strip has a circuit board housed in a protective enclosure, and the circuit board is provided with socket outlets which are connected with the actuators via individual plug connectors. A disadvantage of this is that electrical connection of both the actuators and the electro-magnets to the valve actuation strip is time-consuming, and due to the large number of connectors with associated cables running along the powered support assembly, there are numerous sources of error for potential mechanical, electrical or electronic misconnections. The time required to connect all the actuators to the valve actuation strip is considerable and care must be taken to ensure that, it is possible to detect using the control system which actuator, and therefore which hydraulic valve is connected to which connection on the valve actuation strip. The personnel making the connections must also check carefully that all the connections are made and assigned correctly.

The current assignee has previously proposed and trialled various modifications for said electrohydraulic control systems with valve actuation strips. It is also previously proposed from DE 37 08 902 to connect the controller not by means of individual cables, but by means of a standard terminal block with plain couplers to the valve actuation strip, from which individual cables then run to the electro-magnets. All the plug connections and all the electrical bonds can be made simultaneously through the terminal block and the back of the controller.

DE 197 51 007 has previously proposed a controller for electrohydraulic support control systems which takes a circuit board cast in sealing compound in a rear compartment which directly holds socket outlets that are open at the back of the controller. The casting of the circuit board in sealing compound ensures maximum protection against ingress of moisture and dust. The location of the socket outlets on the circuit board allows a fixed mutual assignment of all the outlets which is adjustable during manufacture of the board, so that the connecting cables for series-connected electro-magnets may be arranged on a joint plug connector and bonded simultaneously on the circuit board in the controller. A problem with this embodiment is however, that the controller is mounted on the adjacent powered support assembly, so that a large number of cables have to run from one powered support assembly to the next.

It is also previously proposed that the control valves of a support unit are combined in a valve block in a preselected pattern of dispersion and, are grouped, for example, in two rows of four or five valves. Said grouping of the control valves in a valve block is previously proposed in DE 101 12 496.

It is the aim of the invention to create an electrohydraulic control system which allows safer and more rapid connection of the control valve actuators, reduces the number of cable connections in the support system, and has fewer sources of error than the state of the art.

Accordingly, the present invention is directed to an electrohydraulic control system as described in the opening paragraph of the present specification, in which the circuit board is located in an enclosure part which is removably attachable to the valve block, which circuit board has attached to it connector parts, for simultaneous connecting of all the actuators of the valve block, the arrangement of which connector parts on the circuit board is matched to the grouping of the actuators on the valve block. As a result of this feature all the actuators are simultaneously connected with the circuit board when the enclosure part is assembled. Furthermore valve cables between a separate terminal block and electro-magnets are not required. Such a wireless connection reduces operational costs and potential sources of error. In addition this type of connection enables personnel to connect all electro-magnets in a single, simple assembly step which takes less time.

In a preferred embodiment the enclosure part comprises a hood with a rear panel and continuous side panel. Said hood not only gives a mechanically robust connection with the valve block and therefore also between the circuit board and the electro-magnets, but when assembled also creates a unit which offers additional protection from outside influences such as water or dust due to the hood-shaped form of the enclosure part. The hood enables all the electronics to be enclosed, so that a greater protection of the electro-magnets and also the control electronics can be achieved than is currently known.

Advantageously a seal is located between the hood and the valve block to ensure greater prevention against ingress of moisture and dust into the interior of the hood compartment.

Preferably the hood comprises a deep-drawn plate, advantageously a brass or steel plate.

In a preferred embodiment, the hood is provided with stiffening ribs, stiffening beads or similar on its rear panel and also on, for example its side panel to make assembly of the hood easier.

Advantageously, there are provided means of alignment on the hood and on the valve block which effect positioning and centering of the hood on the valve block during their assembly, before the connector parts are connected to the actuators.

In a preferred embodiment said alignment means comprises at least one centering pin and at least one associated centering eye, for example, the valve block containing the centering pin and the hood containing the associated centering eye.

Preferably the hood and the valve block are also provided with suitable positive locking means which allows the fixing of the hood in only one possible alignment on the valve block.

In a preferred embodiment the alignment means simultaneously forms the positive locking means, and has several centering pins and associated centering eyes with mutually different cross-sections.

In an alternative embodiment, various centering pins and associated centering eyes are distributed asymmetrically on the valve block and the hood.

Preferably, the circuit board is fixed in parallel to the rear panel of the hood and separated from it by spacers. This method of fixing the circuit board to the hood is especially simple and low in cost.

Advantageously, the circuit board is cast in a sealing compound which fills the gap between the circuit board and the rear panel of the hood so that stable positioning of the circuit board is obtained. Furthermore, the electronic components located on the circuit board are additionally protected against moisture, dust etc.

Preferably the connector parts are provided with base sections, which base sections are provided with connecting pins which are soldered to the circuit board, the connector parts are therefore fixed to the circuit board by means of the connecting pins, the base sections of the connector parts, and the sealing compound.

In a preferred embodiment the sealing compound fills the gap between the circuit board and the rear panel of the hood, and also fills the hood up to a level where the base sections of all the connector parts are enclosed within this sealing compound. In this embodiment the positional fixing of the individual connector parts in the hood is increased after the sealing compound has cured.

Advantageously the connector parts are inserted into plug-in sockets provided at the ends of the actuators.

Preferably at least one sealing element is provided between the connector parts and the sockets.

In a preferred embodiment this sealing element is an O-ring. This sealing element creates an additional seal and further protects the connector parts and sockets against the ingress of dust and moisture.

Advantageously the side panel of the hood is provided with at least one plug-in socket for connection of the circuit board to the controller.

In a preferred embodiment, a connection facility is provided so that the actuators of the valve block and an external circuit board with other actuators connected to it and individual external actuators can also be connected to the circuit board located in the hood.

Preferably the circuit board further comprises at least one electronic booster circuit for a supplementary function, for example earth fault detection, control of external actuators, or processing of signals from sensors.

Advantageously, the hood is secured on the valve block by means of at least one screw.

An example of an electrohydraulic control system made in accordance with the present invention will now be described with reference to the accompanying drawings, in which:

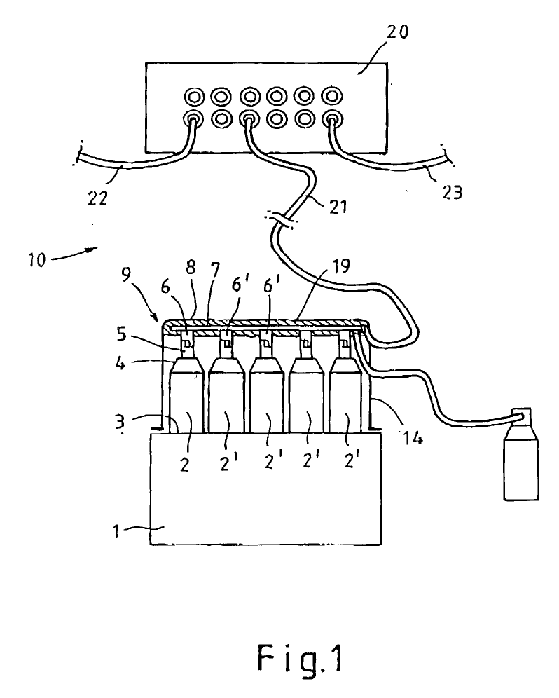

FIG. 1 shows a schematic representation of the system structure of an electrohydraulic control system according to the invention;

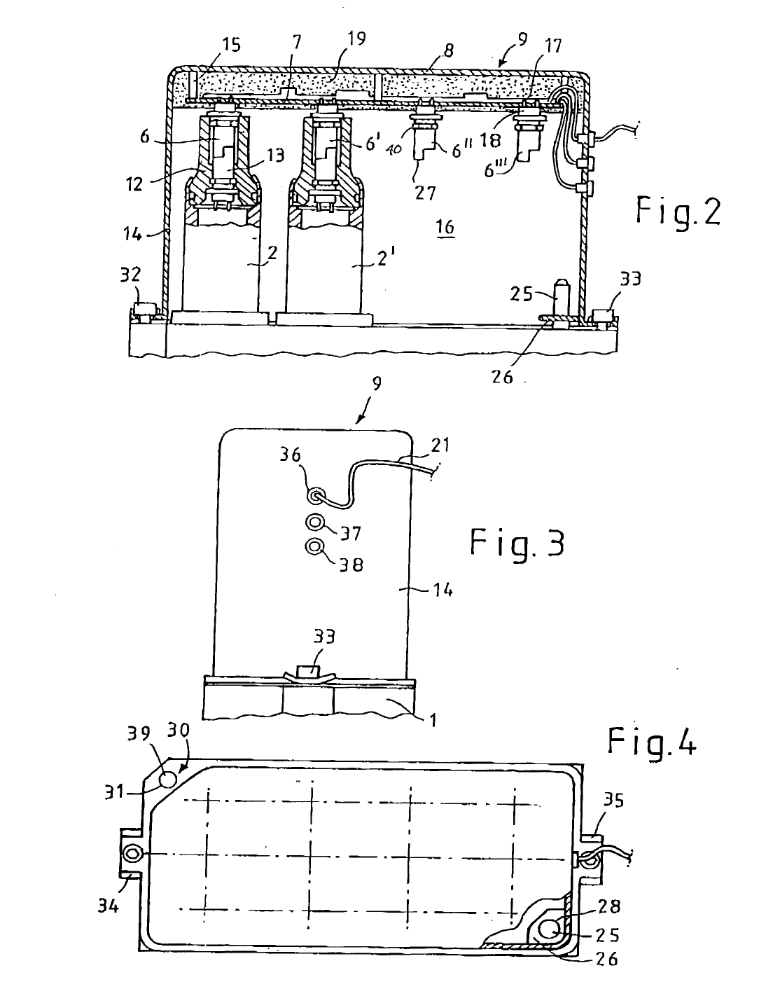

FIG. 2 shows a cross-sectional view of a hood according to the invention with integrated circuit board and connector parts;

FIG. 3 shows a side view of the hood as shown in FIG. 2; and

FIG. 4 shows a top view of the hood as shown in FIG. 3.

FIG. 1 shows a schematic representation of an electrohydraulic support control system 10 comprising a standard valve block 1 in which various rows of location holes (not shown) above and adjacent to each other are formed to take the valve cartridges (not shown) of hydraulic control valves that are switchable as actuators by means of electrically-operated electro-magnets 2, 2′. A separate electro-magnet 2, 2′ is provided for each control valve and the electro-magnets 2, 2′, together with the control valves in valve block 1, are arranged on the back 3 of the valve block 1 and grouped in a preselected pattern of dispersion. The pattern of dispersion may comprise for example of two rows of five electro-magnets 2, 2′. A plug-in socket 5 into which a connector part 6 or 6′ can be inserted for electrical connection of the electro-magnets 2, 2′ is connected at the top 4 of each electromagnet 2, 2′. The connector parts 6, 6′ are fixed on a circuit board 7 which is permanently fixed to the back 8 of a hood 9 and is protected from ingress of dust and moisture by means of sealing compound 19. The circuit board 7 is provided with electronic components and PCB tracks (not shown in detail) in order to switch one or more of the electro-magnets 2, 2′ independently of signals transmitted to the circuit board 7 from a primary controller 20 via the cable connection 21.

The valve block 1 is fixed to a powered support assembly (not shown) of a support system comprising a large number of support units, the controller 20 being itself fixed to the adjacent powered support assembly to control said valve block 1, which in addition to control switches also has an emergency switch and combined electric locks and circuit controllers on the front, so that in emergency situations, e.g. misconnections, the control valves in valve block 1 may be switched manually from a protected position. The controller 20 is linked via cables 22 and 23 to other controllers (not shown) located on the adjacent powered support assemblies or support units.

The invention allows simultaneous connection of all the electro-magnets 2, 2′ with the circuit board 7. The circuit board 7 is located in the back 8 of the hood 9 which is attachable to the back 3 of the valve block 1 which circuit board 7, when the hood 9 is assembled, forms a sheet over all the electro-magnets 2, 2′. This is now explained further with reference to FIGS. 2 to 4.

FIG. 2 shows a cross-sectional view of the enclosure part according in the invention in which various control valves (not shown) are arranged in a preselected grouping in valve block 1 with an electro-magnet 2, 2′ assigned to each as an actuator. Only two electro-magnets 2, 2′ are shown in FIG. 2. All the electro-magnets 2, 2′ have a socket-type upper section 12 comprising an internal connector 13, which together form a plug-in socket 5 (shown schematically in FIG. 1) into which the connector parts 6 to 6′″ that are fixed to the circuit board 7 can be inserted during assembly and, when assembled as shown, engage to connect the electro-magnets 2, 2′ electrically via the connector parts 6 to 6′″ with the circuit board 7. Said connection of the connector parts 6 to 6′″ with the electro-magnets 2, 2′ occurs solely by assembling the hood 9 on the valve block 1.

The hood 9, which preferably comprises a deep-drawn plate, has a rear panel 8 and a continuous side panel 14. The circuit board 7 is set at a distance from the back 8 of the hood 9 by various spacers 15 and is fixed in the compartment 16 inside the hood 9 on the rear panel 8. The circuit board 7 preferably has a thickness of between about 3.2 mm and 3.8 mm and is itself relatively rigid. The circuit board 7 holds various connector parts 6 to 6′″ corresponding to the number and positioning or grouping of the electro-magnets 2, 2′ on the valve block 1. For mechanical and electrical connection with the circuit board 7, said connector parts 6 to 6′″ have at least two and preferably four connecting pins 17 on the back of a base section 18 which are soldered to the circuit board 7. The exact positions of the connector parts 6 to 6′″ on the circuit board 7 are checked and corrected with a gauge before and after soldering of the connecting pins 17, so that the location and alignment of all the connector parts 6 to 6′″ corresponds precisely to the location of the plug-in sockets 5 (shown schematically in FIG. 1) and therefore the socket type upper sections 12 of the electro-magnets 2, 2′. The circuit board 7, the spacers 15 and the base sections 18 of the connector parts 6 to 6′″ are cast in a sealing compound 19 which not only fills the gap between the circuit board 7 and the rear panel 8 of the hood 9, but also covers the top of the circuit board 7 facing the compartment 16 in the hood 9. This cured sealing compound 19 effects additional stiffening of the circuit board 7 with the connector parts 6 to 6′″ held by it, so that the connector parts 6 to 6′″ are basically set rigidly and fixed in their alignment on the circuit board 7.

As FIG. 2 also shows, at least one centering pin 25 is arranged on the valve block 1 and projects over the back of the valve block 1 at least far enough for a centering eye 28 (as shown in FIG. 4) in a centering plate 26 to be guided during assembly on the centering pin 25 located in the compartment 16 of the hood 9 until the tip 27 of the connecting parts 6 to 6′″ comes to the same level as the socket type upper sections 12. As shown in particular in FIG. 4, the centering plate 26 may be fixed, especially welded or soldered, to the centering eye 28 in one of the corners of the side panels 14 of the hood 9. FIG. 4 also shows that the enclosure 9 contains a second centering means 30 which comprises a centering eye 31 and an associated centering pin 39 on the valve block 1. The diameter of the centering eye 31 of the centering means 30 is less than that of the centering eye 28, so that the hood 9 may only be brought in proximity to the back of the valve block 1 and fixed to it in one of two theoretically possible positions and alignments. The centering means 30 is located on the outside of the hood 9 and the other centering means 25, 28 are located in the compartment 16 of the hood 9.

In the assembled form, as shown in FIG. 2, in which the connector parts 6 to 6′″ engage fully in the socket-type upper sections 12, the hood 9 will engage via screws 32, 33 through the attachment studs 34, 35 (as shown in FIG. 4) on the short transverse sides of the side panel 14, fixed in associated tapped holes in the valve block 1. In the assembled form, an O-ring 40 sits in a stop notch on the connector parts 6 to 6′″ lying inside the socket type upper sections 12 of the electro-magnets 2, 2′, sealing against ingress of dust and moisture into the electro-magnets 2, 2′. The O-rings 40 act only as additional protection, however, because a continuous seal (not shown) is fitted between the hood 9 and the valve block 1 to prevent moisture penetrating to the compartment 16 of the hood 9 in the assembled form.

As shown schematically in FIG. 1, the circuit board 7 can be connected to the controller 20 via a cable 21 which passes through a cable gland (not shown) in one of the transverse sides or longitudinal sides of the enclosure 9. Alternatively, for example, as shown in FIG. 3, several plug-in sockets 36, 37, 38 are provided on one of the transverse sides of the side panel 14 of the hood 9, the plug-in socket 36 serving to connect the controller 20 (as shown schematically in FIG. 1) by means of cable 21 and associated cable connector (not shown), while other circuit boards (not shown) from other valve blocks or external electro-magnets may be connected through plug-in sockets 37 and 38.

For a person skilled in the art, the above-mentioned description gives rise to a series of modifications which fall within the scope of protection of the attached claims. The number of electro-magnets on the valve block and their associated connector parts on the circuit board may vary. The connector parts shown in the Figures form the preferred connector, but other connectors may also be used. The circuit electronics may contain additional functions for example such as earth fault detection. Other alignment and positive locking means may be provided on the hood and valve block. The valve block could have an asymmetrical shoulder over which the hood may only form a sheet in one alignment. The centering pins could also be formed on the hood and engage in corresponding holes in the valve block. Other actuators, such as piezoelectric actuators may be used instead of electro-magnets.

1. An electrohydraulic control system for an underground support system with a valve block which accepts grouped electrically-operated actuators and several control valves for hydraulic valves switched with the said actuators, which electrohydraulic control system further comprises a circuit board containing an electronic circuit to which all the actuators of the valve block are connectable through a disconnectable plug connector, by which disconnectable plug connector the circuit board is connectable to a controller for data communication, data recording and evaluation from operational status data support units connected thereto, in which the circuit board is located in an enclosure part which is removably attachable to the valve block, which circuit board has attached to it connector parts for simultaneous connecting of all the actuators of the valve block, the arrangement of which connector parts on the circuit board is matched to the grouping of the actuators on the valve block.

2. An electrohydraulic control system according to claim 1, in which the enclosure part comprises a hood with rear panel and continuous side panel.

3. An electrohydraulic control system according to claim 2, in which a seal is located between the hood and the valve block.

4. An electrohydraulic control system according to claim 2, in which the hood comprises a deep-drawn plate.

5. An electrohydraulic control system according to claim 4, in which the deep-drawn plate is made of brass or steel.

6. An electrohydraulic control system according to claim 2, in which the hood is provided with stiffening means.

7. An electrohydraulic control system according to claim 6, in which the hood is provided with stiffening means in its rear panel and side panel.

8. An electrohydraulic control system according to claim 1, in which alignment means are provided on the enclosure part and on the valve block which effect positioning and centering of the enclosure part on the valve block during their assembly before the connection of the connector parts with the actuators.

9. An electrohydraulic control system according to claim 8, in which the alignment means comprise at least one centering pin and at least one associated centering eye.

10. An electrohydraulic control system according to claim 2, in which the hood and the valve block are provided with positive locking means which allows the fixing of the hood in only one possible alignment on the valve block.

11. An electrohydraulic control system according to claim 10, in which the alignment means also forms the positive locking means and comprises several centering pins and associated centering eyes with mutually different cross-sections.

12. An electrohydraulic control system according to claim 2, in which the circuit board is fixed in parallel to the rear panel of the hood and separated from it by spacers.

13. An electrohydraulic control system according to claim 12, in which the circuit board is cast in sealing compound which fills the gap between the circuit board and the rear panel of the hood.

14. An electrohydraulic control system according to claim 1, in which the connector parts are provided with base sections, which base sections are provided with connecting pins which are soldered to the circuit board, the connector parts are fixed to the circuit board by means of the connecting pins, base sections and sealing compound.

15. An electrohydraulic control system according to claim 14, in which the connector parts and their associated base sections and connecting pins are fixed to the circuit board by a sealing compound.

16. An electrohydraulic control system according to claim 1, in which the connector parts are inserted into plug-in sockets provided on the ends of the actuators.

17. An electrohydraulic control system according to claim 16, in which at least one sealing element is provided between the connector parts and the plug-in sockets.

18. An electrohydraulic control system according to claim 17, in which the sealing element comprises an O-ring.

19. An electrohydraulic control system according to claim 2, in which the hood is provided in its side panel with at least one plug-in socket for connection of the circuit board to the controller.

20. An electrohydraulic control system according to claim 1, in which the circuit board located in the enclosure part has at least one connection facility for external circuit boards or individual external actuators.

21. An electrohydraulic control system according to claim 1, in which the circuit board contains at least one electronic booster circuit for additional functions, for example earth fault detection, control of external actuators, or processing of signals from sensors.

22. An electrohydraulic control system according to claim 1, in which the enclosure part is attachable by means of at least one screw to the valve block.
